(19) United States
(12) Patent Application Publication
(10) Pub. No.: US 2008/0061155 A1
(43) Pub. Date: Mar. 13, 2008

(54) Heated water recirculation system and thermostatic valve assembly for same

(76) Inventor: Paul Steven Seymour, Staffordshire (GB)

Correspondence Address: David O. Simmons;Galasso & Associates LP, P.O. Box 26503, Austin, TX, 26503, US

(21) Appl. No.: 11/519,582

(22) Filed: Sep. 12, 2006

(51) Int. Cl. G05D 23/185; G05D 23/13

(52) U.S. Cl. 236/12.11; 236/12.15

(57) ABSTRACT

A water faucet comprises a valve body, a thermostatic flow control device and a first manually operated flow regulating device. The valve body has therein a water outlet channel, a water inlet channel, a water return channel and a flow control device cavity. The water outlet channel extends between the flow control device cavity and a water outlet port of the valve body. The water inlet channel extends between the flow control device cavity and a water inlet port of the valve body. The water return channel extends between the flow control device cavity and a water return port of the valve body. The thermostatic flow control device is mounted within the flow control device cavity of the valve body. The thermostatic flow control device blocks the water outlet channel and unblocks the water return channel when water in the flow control device cavity is below a prescribed minimum temperature. The thermostatic flow control device unblocks the water outlet channel and blocks the water return channel when water in the flow control device cavity is above the prescribed minimum temperature. The first manually operated flow regulating device is attached to the valve body and extends into the water inlet channel for enabling the flow of water through the water inlet channel to be manually and selectively controlled.

### FIELD OF THE DISCLOSURE

The disclosures made herein relate generally to water conservation implementations in plumbing articles and, more particularly, to water recirculation systems and plumbing articles for enabling water recirculation.

### BACKGROUND

Most building structures include a heated water supply system, regardless of whether the building is designed and/or used for industrial, commercial or residential purposes. It is a fact that heated water supply system that include a water heater at a remote location from a water outlet apparatus (e.g., a faucet) result in a considerable amount of wasted water. When a person open a water outlet apparatus for the purpose of dispensing hot water, the water line between the water heater and the water outlet apparatus must first be purged of residual water, which may be at room temperature or ambient temperature depending on the routing of the water line. Once the residual water is purged from the water line between the water heater and the water outlet apparatus, heated water from the water heater will begin to be dispensed. This approach and need for first purging the water line of unheated water prior to receiving heated water from the water heater results in wasted water each time there is a need to dispensing hot water. In the worst case, the volume of water wasted each time there is a need to dispensing hot water is about equal to the volume of water held within the length of water line extending between the water heater and the water outlet apparatus.

Therefore, a heated water supply circuit that reduces or eliminates the wasting on unheated water prior to dispensing of heated water is useful.

### SUMMARY OF THE DISCLOSURE

Embodiments of the present invention enable heated water to be supplied in a manner that reduces or eliminates the wasting of unheated water prior to dispensing of the heated water. More specifically, embodiments of the present invention preclude water from being dispensed from a heated water supply circuit until the heated water would be at a prescribed minimum temperature. In this manner, embodiments of the present invention advantageously conserve water.

In one embodiment of the present invention, a water faucet comprises a valve body, a thermostatic flow control device and a waterspout. The valve body has therein a water outlet channel, a water inlet channel, a water return channel and a flow control device cavity. The water outlet channel extends between the flow control device cavity and a water outlet port of the valve body. The water inlet channel extends between the flow control device cavity and a water inlet port of the valve body. The water return channel extends between the flow control device cavity and a water return port of the valve body. The thermostatic flow control device is mounted within the flow control device cavity of the valve body. The thermostatic flow control device blocks the water outlet channel and unblocks the water return channel when water in the flow control device cavity is below a prescribed minimum temperature. The thermostatic flow control device unblocks the water outlet channel and blocks the water return channel when water in the flow control device cavity is above the prescribed minimum temperature. The waterspout is attached to the valve body over the water outlet port.

In another embodiment of the present invention, a water faucet comprises a valve body, a thermostatic flow control device and a first manually operated flow regulating device. The valve body has therein a water outlet channel, a water inlet channel, a water return channel and a flow control device cavity. The water outlet channel extends between the flow control device cavity and a water outlet port of the valve body. The water inlet channel extends between the flow control device cavity and a water inlet port of the valve body. The water return channel extends between the flow control device cavity and a water return port of the valve body. The thermostatic flow control device is mounted within the flow control device cavity of the valve body. The thermostatic flow control device blocks the water outlet channel and unblocks the water return channel when water in the flow control device cavity is below a prescribed minimum temperature. The thermostatic flow control device unblocks the water outlet channel and blocks the water return channel when water in the flow control device cavity is above the prescribed minimum temperature. The first manually operated flow regulating device is attached to the valve body and extends into the water inlet channel. The first manually operated flow regulating device enables the flow of water through the water inlet channel to be manually and selectively controlled.

In another embodiment of the present invention, a heated water recirculation system for a building structure comprises a recirculation valve assembly, a water heater and a water pump. The recirculation valve assembly includes a valve body and a thermostatic flow control device mounted within a cavity of the valve body. A water outlet channel, a water inlet channel, and a water return channel each terminate at a first respective end thereof at the cavity. The thermostatic flow control device blocks the water outlet channel and unblocks the water return channel when water in the flow control device cavity is below a prescribed minimum temperature. The thermostatic flow control device unblocks the water outlet channel and blocks the water return channel when water in the flow control device cavity is above the prescribed minimum temperature. The water heater has a water supply inlet and a heated water outlet. The heated water outlet is connected to a respective second end of the water inlet channel. The water pump has a return water inlet and pressurized water outlet. The return water inlet is connected to the respective second end of the water return channel and the pressurized water outlet is connected to the water supply inlet of the water heater.

Turning now to specific aspects of the present invention, in at least one embodiment, a first manually operated flow regulating device is attached to the valve body and extends into the water inlet channel for enabling the flow of water through the water inlet channel to be manually and selectively controlled

In at least one embodiment of the present invention, a second manually operated flow regulating device is attached to the valve body and extends into a cold water flow channel of the valve body for enabling a flow of water through the cold water flow channel to be manually and selectively controlled.

In at least one embodiment of the present invention, the thermostatic flow control device includes a thermally sensitive material assembly that causes a flow control member to block the flow of water though the water outlet channel and unblock the flow of water through the water return channel when the thermally sensitive material assembly is exposed to the water that is below a prescribed minimum temperature and that causes the flow control member to unblock the flow of water though the water outlet channel and block the flow of water through the water return channel when the thermally sensitive material assembly is exposed to the water that is above the prescribed minimum temperature.

In at least one embodiment of the present invention, a manually operated flow regulating device is connected between the heated water outlet of the water heater and the water inlet channel of the valve body, extending into the water inlet channel for enabling the flow of water through the water inlet channel to be manually and selectively controlled.

These and other objects, embodiments, advantages and/or distinctions of the present invention will become readily apparent upon further review of the following specification, associated drawings and appended claims.

### BRIEF DESCRIPTION OF THE DRAWINGS

FIG. 1 is a diagrammatic view showing an embodiment of a heated water recirculation system in accordance with the present invention.

FIG. 2 is a cross-sectional view of a facet assembly taken along the line 2-2 in FIG. 1, wherein a thermostatic flow control device of the facet assembly is in a position permitting return flow of water.

FIG. 3 is a cross-sectional view of a facet assembly taken along the line 2-2 in FIG. 1, wherein a thermostatic flow control device of the facet assembly is in a position precluding return flow of water.

FIG. 4 is a cross-sectional view of a dual-control valve body in accordance with the present invention.

### DETAILED DESCRIPTION OF THE DRAWING FIGURES

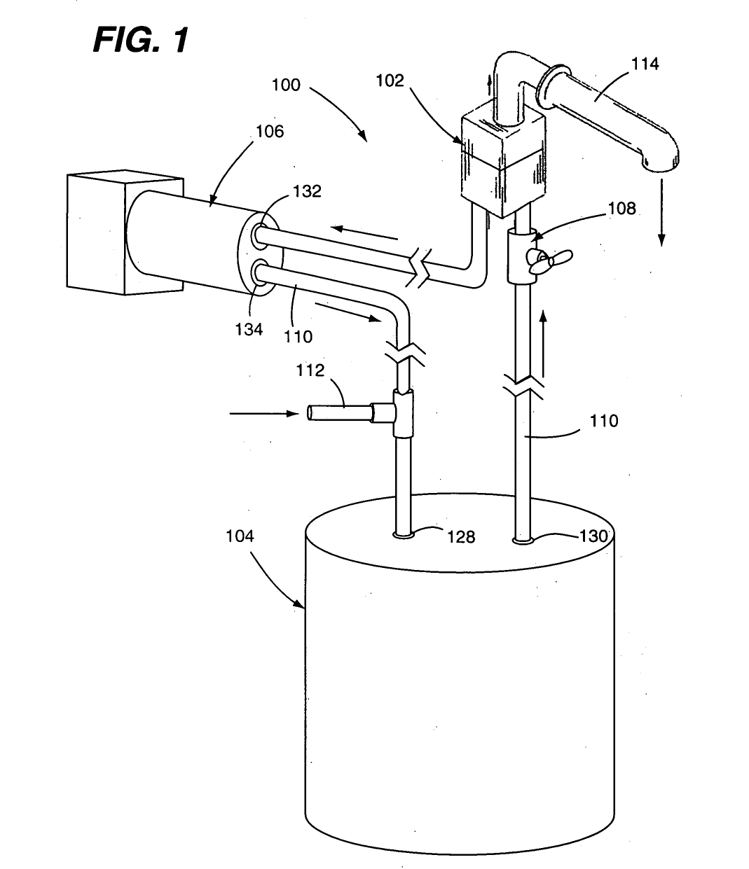

FIG. 1 shows an embodiment of a heated water recirculation system in accordance with the present invention, which is referred to herein as the heated water recirculation system 100. The heated water recirculation system 100 includes a recirculation valve assembly 102, a water heater 104, a water pump 106, a manually operated-flow regulating device 108 and piping components 110 (e.g., pipe, elbows, Tees, etc). The piping components 110 (e.g., pipe, elbows, Tees, etc) are interconnected between the recirculation valve assembly 102, the water heater 104, the water pump 106 and the manually operated flow regulating device 108.

Upon opening of the manually operated flow regulating device 108, water is supplied from the water heater 104 to the recirculation valve assembly 102. The manually operated flow regulating device 108 (e.g., a water valve) enables a flow of water through the water inlet channel to be manually and selectively controlled Until the water is at or above a prescribed minimum temperature, the water is recirculated back to the water heater 104. The water pump 106 serves to pressurize the water being recirculated to the water heater 104 so as to effectively shut off water supplied via a water supply line 112. The recirculation valve assembly 102 precludes water from being dispensed through a water spout 114 of the recirculation valve assembly 102 until the water supplied to the recirculation valve assembly 102 is at or above a prescribed minimum temperature. To this end, the recirculation valve assembly 102 recirculates the water supplied to the recirculation valve assembly 102 from the water heater 104 back to the water heater 104 until the water at the recirculation valve assembly 104 is at or above the prescribed minimum temperature. In this manner, the heated water recirculation system 100 reduces or eliminates the wasting of unheated water prior to dispensing of heated water.

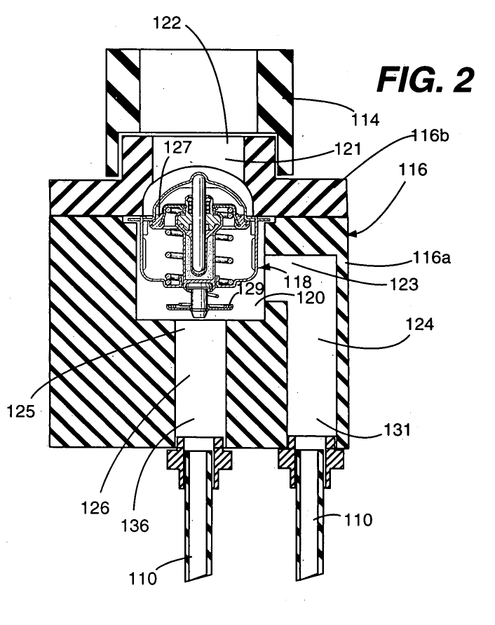

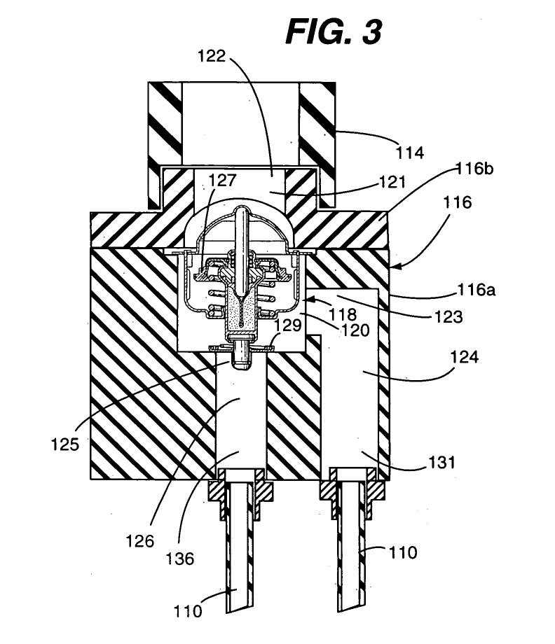

Referring now to FIGS. 2 and 3, the recirculation valve assembly 102 including a valve body 116 and a thermostatic flow control device 118 mounted within a cavity 120 of the valve body 116. As shown, the valve body 116 includes a main portion 116a and a cap portion 116b. However, it is disclosed herein that the valve body 116 may include less than two discrete portions or more than two discrete portions.

The valve body 116 includes a water outlet channel 122, a water inlet channel 124 and a water return channel 126. A first end 121 of the water outlet channel 122, a first end 123 of the water inlet channel 124 and a first end 125 of the water return channel 126 each terminate at the cavity 120. Thus, a plurality of water flow paths are formed by the water outlet channel 122, the water inlet channel 124, the water return channel 126 and the cavity 120. A heated water outlet flow path consists of the water outlet channel 122, the water inlet channel 124 and the cavity 120. A heated water return flow path consists of the water return channel 126, the water inlet channel 124 and the cavity 120.

The thermostatic flow control device 118 serves the function of causing water to flow through either the heated water outlet flow path or the heated water return flow path. As shown in FIG. 2, when water within the cavity 120 is below the prescribed minimum temperature, a first flow control member 127 of the thermostatic flow control device 118 blocks the water outlet channel 122 (i.e., prevents water flow therethrough) and a second flow control member 129 of the thermostatic flow control device 118 unblocks water return channel 126 i.e., allows water flow therethrough) such that water flows through the heated water return flow path. As shown in FIG. 3, when water within the cavity 120 is above the prescribed minimum temperature, the first flow control member 127 of the thermostatic flow control device 118 unblocks the water outlet channel 122 (i.e., allows water flow therethrough) and the second flow control member 129 of the thermostatic flow control device 118 blocks water return channel 126 (i.e., prevents water flow therethrough) such that water flows through the heated water outlet flow path.

Various types and configurations of thermostatic flow control devices suitable for implementation in accordance with the present invention are well known and are commercially available through any number of sources. Automotive thermostats such as those disclosed in U.S. Pat. Nos. 5,992,755, 4,344,564, 4,196,847 and 5,979,778 are examples of such thermostatic flow control devices. These and similar types of types of thermostats include a thermally sensitive material assembly that causes displacement of the flow control members (127, 129). Although not necessary for carrying out the present invention, it is disclosed herein that an application specific thermostatic flow control device that provides the function of selectively blocking the water outlet channel 122 and unblock water return channel 126 such that water flows through the heated water return flow path when water within the cavity 120 is below the prescribed minimum temperature and selectively unblocking the water outlet channel 122 and blocking the water return channel 126 when water within the cavity 120 is below the prescribed minimum temperature may be developed for use with the present invention.

Referring now to FIGS. 1-3, the water heater 104 has a water supply inlet 128 and a heated water outlet 130. The heated water outlet 130 of the water heater 104 is connected to a second end 131 of the water inlet channel 124. The water pump 106 has a return water inlet 132 and pressurized water outlet 134. The return water inlet 132 of the water pump 106 is connected to a second end portion 136 of the water return channel 126. The pressurized water outlet 134 of the water pump 106 is connected to the water supply inlet 128 of the water heater 104.

As discussed above, the water pump 106 serves to pressurize the water being recirculated to the water heater 104 so as to effectively shut off water supplied via the water supply line 112. To this end, it is disclosed herein that the water pump 106 includes means for pressurizing water (e.g., an electrical motor connected to an impeller assembly) and mean for selective activation (e.g., a sensor for detecting water pressure at the return water inlet 132 of the water pump 106). The water pump 106 turns on when needed to pump water back into the water heater 104. A check valve may be installed in series within the water supply line 112 to prevent backflow of water during operation of the water pump 106.

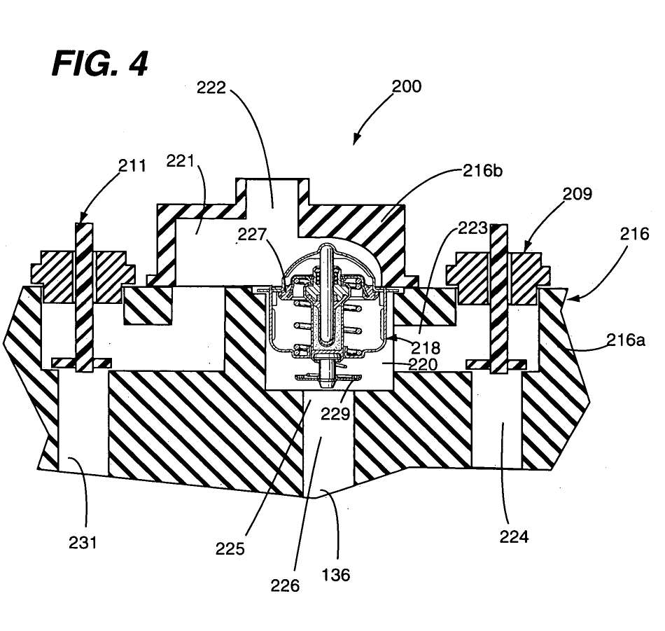

FIG. 4 shows an embodiment of a dual flow water faucet in accordance with the present invention, which is referred to herein as the water faucet 200. It is disclosed herein that the water faucet 200 may be implemented in place of the recirculation valve assembly 102 and the manually operated flow regulating device 108 in the system 100. The water faucet 200 includes a first manually operated flow regulating device 209, a second manually operated flow regulating device 211, a valve body 216 and a thermostatic flow control device 218. The thermostatic flow control device 218 is mounted within a cavity 220 of the valve body 216. As shown, the valve body 216 includes a main portion 216a and a cap portion 216b. However, it is disclosed herein that the valve body 216 may include less than two discrete portions or more than two discrete portions.

The valve body 216 includes a water outlet channel 222, a heated water inlet channel 224 and a heated water return channel 226. A first end 221 of the water outlet channel 222, a first end 223 of the heated water inlet channel 224 and a first end 225 of the heated water return channel 226 each terminate at the cavity 220. Thus, a plurality of water flow paths are formed by the water outlet channel 222, the heated water inlet channel 224, the heated water return channel 226 and the cavity 220. A heated water outlet flow path consists of the water outlet channel 222, the heated water inlet channel 224 and the cavity 220. A heated water return flow path consists of the heated water return channel 226, the heated water inlet channel 224 and the cavity 220. In addition to the heated water flow paths, an unheated water flow path is provided. The unheated water flow path includes the water outlet channel 222 and an unheated water inlet channel 231.

The thermostatic flow control device 218 serves the function of causing water to flow through either the heated water outlet flow path or the heated water return flow path. As shown in FIG. 4, when water within the cavity 120 is below the prescribed minimum temperature, a first flow control member 227 of the thermostatic flow control device 218 blocks the water outlet channel 222 (i.e., prevents water flow therethrough) and a second flow control member 229 of the thermostatic flow control device 218 unblocks water return channel 226 (i.e., allows water flow therethrough) such that water flows through the heated water return flow path. When water within the cavity 220 is above the prescribed minimum temperature, the first flow control member 227 of the thermostatic flow control device 218 unblocks the water outlet channel 222 (i.e., allows water flow therethrough) and the second flow control member 129 of the thermostatic flow control device 218 blocks water return channel 226 i.e., prevents water flow therethrough) such that water flows through the heated water outlet flow path.

The first manually operated flow regulating device 209 is attached to the valve body 216 and extends into the heated water inlet channel 224. The second manually operated flow regulating device 211 is attached to the valve body 216 and extends into the unheated water inlet channel 231. The first manually operated flow regulating device 209 enables the flow of water through the heated water inlet channel 224 to be manually and selectively controlled. The second manually operated flow regulating device 211 enables the flow of water through the unheated water inlet channel 231 to be manually and selectively controlled. Accordingly, a mix of unheated and heated water may be achieved through individual manipulation of the manually operated flow regulating devices (209, 211).

In the preceding detailed description, reference has been made to the accompanying drawings that form a part hereof, and in which are shown by way of illustration specific embodiments in which the present invention may be practiced. These embodiments, and certain variants thereof, have been described in sufficient detail to enable those skilled in the art to practice embodiments of the present invention. It is to be understood that other suitable embodiments may be utilized and that logical, mechanical, chemical and electrical changes may be made without departing from the spirit or scope of such inventive disclosures. To avoid unnecessary detail, the description omits certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A water faucet, comprising:
a valve body having therein a water outlet channel, a water inlet channel, a water return channel and a flow control device cavity, wherein the water outlet channel extends between the flow control device cavity and a water outlet port of the valve body, wherein the water inlet channel extends between the flow control device cavity and a water inlet port of the valve body and wherein the water return channel extends between the flow control device cavity and a water return port of the valve body;
a thermostatic flow control device mounted within the flow control device cavity of the valve body, wherein the thermostatic flow control device blocks the water outlet channel and unblocks the water return channel when water within the flow control device cavity is below a prescribed minimum temperature and wherein the thermostatic flow control device unblocks the water outlet channel and blocks the water return channel when water within the flow control device cavity is above the prescribed minimum temperature; and
a waterspout attached to the valve body over the water outlet port.

2. The water faucet of claim 1, further comprising:
a first manually operated flow regulating device attached to the valve body and extending into the water inlet channel, wherein the first manually operated flow regulating device enables the flow of water through the water inlet channel to be manually and selectively controlled.

3. The water faucet of claim 2, further comprising:
a second manually operated flow regulating device attached to the valve body, wherein a cold water flow channel extends between a cold water supply inlet port and the water outlet port of the valve body, wherein the second manually operated flow regulating device extends into the cold water flow channel for enabling a flow of water through the cold water flow channel to be manually and selectively controlled.

4. The water faucet of claim 2 wherein the thermostatic flow control device includes a thermally sensitive material assembly that:
causes a flow control member to block the flow of water though the water outlet channel and unblock the flow of water through the water return channel when the thermally sensitive material assembly is exposed to said water that is below a prescribed minimum temperature; and
causes the flow control member to unblock the flow of water though the water outlet channel and block the flow of water through the water return channel when the thermally sensitive material assembly is exposed to said water that is above the prescribed minimum temperature.

5. The water faucet of claim 1 wherein the thermostatic flow control device includes a thermally sensitive material assembly that:
causes a flow control member to block the flow of water though the water outlet channel and unblock the flow of water through the water return channel when the thermally sensitive material assembly is exposed to said water that is below a prescribed minimum temperature; and
causes the flow control member to unblock the flow of water though the water outlet channel and block the flow of water through the water return channel when the thermally sensitive material assembly is exposed to said water that is above the prescribed minimum temperature.

6. A water faucet, comprising:
a valve body having therein a water outlet channel, a water inlet channel, a water return channel and a flow control device cavity, wherein the water outlet channel extends between the flow control device cavity and a water outlet port of the valve body, wherein the water inlet channel extends between the flow control device cavity and a water inlet port of the valve body and wherein the water return channel extends between the flow control device cavity and a water return port of the valve body;
a thermostatic flow control device mounted within the flow control device cavity of the valve body, wherein the thermostatic flow control device blocks the water outlet channel and unblocks the water return channel when water within the flow control device cavity is below a prescribed minimum temperature and wherein the thermostatic flow control device unblocks the water outlet channel and blocks the water return channel when water within the flow control device cavity is above the prescribed minimum temperature; and
a first manually operated flow regulating device attached to the valve body and extending into the water inlet channel, wherein the first manually operated flow regulating device enables the flow of water through the water inlet channel to be manually and selectively controlled.

7. The water faucet of claim 6, further comprising:
a second manually operated flow regulating device attached to the valve body, wherein a cold water flow channel extends between a cold water supply inlet port and the water outlet port of the valve body, wherein the second manually operated flow regulating device extends into the cold water flow channel for enabling a flow of water through the cold water flow channel to be manually and selectively controlled.

8. The water faucet of claim 7 wherein the thermostatic flow control device includes a thermally sensitive material assembly that:
causes a flow control member to block the flow of water though the water outlet channel and unblock the flow of water through the water return channel when the thermally sensitive material assembly is exposed to said water that is below a prescribed minimum temperature; and
causes the flow control member to unblock the flow of water though the water outlet channel and block the flow of water through the water return channel when the thermally sensitive material assembly is exposed to said water that is above the prescribed minimum temperature.

9. The water faucet of claim 6 wherein the thermostatic flow control device includes a thermally sensitive material assembly that:
causes a flow control member to block the flow of water though the water outlet channel and unblock the flow of water through the water return channel when the thermally sensitive material assembly is exposed to said water that is below a prescribed minimum temperature; and
causes the flow control member to unblock the flow of water though the water outlet channel and block the flow of water through the water return channel when the thermally sensitive material assembly is exposed to said water that is above the prescribed minimum temperature.

10. A heated water recirculation system for a building structure, comprising:
a recirculation valve assembly including a valve body and a thermostatic flow control device mounted within a cavity of the valve body, wherein a water outlet channel, a water inlet channel, and a water return channel each terminate at a first respective end thereof at the cavity, wherein the thermostatic flow control device blocks the water outlet channel and unblocks the water return channel when water within the flow control device cavity is below a prescribed minimum temperature and wherein the thermostatic flow control device unblocks the water outlet channel and blocks the water return channel when water within the flow control device cavity is above the prescribed minimum temperature;
a water heater having a water supply inlet and a heated water outlet, wherein the heated water outlet is connected to a respective second end of the water inlet channel;
a water pump having a return water inlet and pressurized water outlet, wherein the return water inlet is connected to the respective second end of the water return channel and wherein the pressurized water outlet is connected to the water supply inlet of the water heater.

11. The heated water recirculation system of claim 10, further comprising:
a first manually operated flow regulating device attached to the valve body and extending into the water inlet channel, wherein the first manually operated flow regulating device enables the flow of water through the water inlet channel to be manually and selectively controlled.

12. The heated water recirculation system of claim 11, further comprising:
a second manually operated flow regulating device attached to the valve body, wherein a cold water flow channel extends between a cold water supply inlet port and the water outlet port of the valve body, wherein the second manually operated flow regulating device extends into the cold water flow channel for enabling a flow of water through the cold water flow channel to be manually and selectively controlled.

13. The heated water recirculation system of claim 11 wherein the thermostatic flow control device includes a thermally sensitive material assembly that:
causes a flow control member to block the flow of water though the water outlet channel and unblock the flow of water through the water return channel when the thermally sensitive material assembly is exposed to said water that is below a prescribed minimum temperature; and
causes the flow control member to unblock the flow of water though the water outlet channel and block the flow of water through the water return channel when the thermally sensitive material assembly is exposed to said water that is above the prescribed minimum temperature.

14. The heated water recirculation system of claim 10 wherein the thermostatic flow control device includes a thermally sensitive material assembly that:
causes a flow control member to block the flow of water though the water outlet channel and unblock the flow of water through the water return channel when the thermally sensitive material assembly is exposed to said water that is below a prescribed minimum temperature; and
causes the flow control member to unblock the flow of water though the water outlet channel and block the flow of water through the water return channel when the thermally sensitive material assembly is exposed to said water that is above the prescribed minimum temperature.

15. The heated water recirculation system of claim 10, further comprising:
a manually operated flow regulating device connected between the heated water outlet of the water heater and the water inlet channel of the valve body, wherein the manually operated flow regulating device enables a flow of water through the water inlet channel to be manually and selectively controlled.

16. The heated water recirculation system of claim 15 wherein the thermostatic flow control device includes a thermally sensitive material assembly that:
causes a flow control member to block the flow of water though the water outlet channel and unblock the flow of water through the water return channel when the thermally sensitive material assembly is exposed to said water that is below a prescribed minimum temperature; and
causes the flow control member to unblock the flow of water though the water outlet channel and block the flow of water through the water return channel when the thermally sensitive material assembly is exposed to said water that is above the prescribed minimum temperature.
